(19) United States
(12) Patent Application Publication
(10) Pub. No.: US 2012/0120674 A1
(43) Pub. Date: May 17, 2012

(54) Mobile Lighting Apparatus

(76) Inventor: John Jonker, (US)

(21) Appl. No.: 13/356,022

(22) Filed: Jan. 23, 2012

(30) Foreign Application Priority Data
Aug. 5, 2010 (AU) 2010903499

(51) Int. Cl. F21V 21/30

(52) U.S. Cl. 362/523

(57) ABSTRACT

Mobile lighting apparatus, including:
a steerable vehicle having a body supported on a pair of spaced apart rear wheels and a pair of spaced apart front wheels;
drive means operatively connected to at least one of said pair of rear wheels and said pair of front wheels for driving the vehicle along the ground;
an extendable boom pivotally mounted to said body at or near its rear end for movement relative thereto between a lowered position and a raised position with the longitudinal axis of the boom remaining generally in the same vertical plane relative to the rear wheels;
lighting means operatively connected to said boom at or adjacent its end distal from said vehicle body;
electricity generation means mounted to said vehicle body behind said extendable boom adjacent its proximal end; and
electricity communication means connecting said electricity generation means to said lighting means.

This invention relates to mobile lighting apparatus.

The invention has particular application to mobile lighting apparatus of the type in which an array of lights is mounted to a boom which can be raised when in a desired location for directing light onto a selected area and lowered for transport to another desired location or site.

One known mobile lighting apparatus includes a trailer with a boom and an array of lights mounted thereon which can be raised from a lowered position in which the boom is horizontal and can be secured in the horizontal position to a raised or elevated position in which the boom is vertical and can be secured in the raised position. Such apparatus provides for operation of the lights only when the boom is in the vertical position and provides for securement of the boom only in the horizontal and vertical positions.

The present invention is aimed at providing mobile lighting apparatus which can be more easily moved than a trailer from one site to another. The invention is also aimed at providing mobile lighting apparatus which can supply more powerful lighting than previously known mobile lighting apparatus. The invention is also aimed at providing mobile lighting apparatus in which the lights can be operated in a large range of positions.

With the foregoing in view, the present invention resides broadly in mobile lighting apparatus, including:

a steerable vehicle having a body supported on a pair of spaced apart rear wheels and a pair of spaced apart front wheels;

drive means operatively connected to at least one of said pair of rear wheels and said pair of front wheels for driving the vehicle along the ground;

an extendable boom pivotally mounted to said body at or near its rear end for movement relative thereto between a lowered position and a raised position with the longitudinal axis of the boom remaining generally in the same vertical plane relative to the rear wheels;

lighting means operatively connected to said boom at or adjacent its end distal from said vehicle body;

electricity generation means mounted to said vehicle body behind said extendable boom adjacent its proximal end whereby said electricity generation means acts as a counterweight for said boom and said lighting means; and

electricity communication means connecting said electricity generation means to said lighting means.

In another aspect, the invention resides broadly in mobile lighting apparatus, including:

a steerable vehicle having a body supported on a pair of spaced apart rear wheels and a pair of spaced apart front wheels;

drive means operatively connected to at least one of said pair of rear wheels and said pair of front wheels for driving the vehicle along the ground;

an extendable boom pivotally mounted to said body at or near its rear end for movement relative thereto between a lowered position and a raised position with the longitudinal axis of the boom remaining generally in the same vertical plane relative to the rear wheels;

lighting means operatively connected to said boom at or adjacent its end distal from said vehicle body;

electricity generation means mounted to said vehicle body beside said extendable boom adjacent its proximal end whereby said electricity generation means acts as a counterweight for said boom and said lighting means; and

electricity communication means connecting said lighting means to said electricity generation means.

Preferably, said electricity generation means includes an internal combustion engine and an alternator or generator coupled thereto. It is also preferred that said electricity generation means be mounted on a platform which overhangs said body such that in use, the platform is closer to the ground than the body such that in cases where the wheels sink into the ground the platform engages the ground and supports the body thereby keeping the electricity generation means above ground level.

Preferably, said drive means includes an engine and gearbox or one or more hydraulic motors drivingly connected to the wheels independently of the electricity generation means for fairly high road speed travel, above about 30 kmph. Advantageously, such arrangement allows the apparatus to be quickly taken to a site in an emergency situation.

In another aspect, the invention resides broadly in a method of converting a vehicle to lighting apparatus as previously described, the vehicle being a steerable vehicle having a body supported on a pair of spaced apart rear wheels and a pair of spaced apart front wheels and drive means operatively connected to at least one of said pair of front wheels and said pair of rear wheels for driving the vehicle along the ground, an extendable boom pivotally mounted to said body at or near its rear end for movement relative thereto between a lowered position and a raised position with the longitudinal axis of the boom remaining generally in the same vertical plane relative to the rear wheels, and a counterweight mounted to said body to counter the weight of the boom, the method including:

connecting lighting means to said boom at or adjacent its distal end;

removing the counterweight at least in part and mounting electricity generation means to said body in a predetermined position in place of the removed counterweight; and

electrically connecting the electricity generation means to the lighting means.

Preferably, said predetermined position is selected such that the electricity generation means acts as a suitable counterweight for the boom and the lighting means mounted thereon when fully extended.

The terms “horizontal” and ‘vertical” are intended to describe the orientation of the particular axis or component being referred to when the apparatus is at rest on a level horizontal surface even though the axis or component may not be geometrically exactly vertical or horizontal. Further, such terms are not intended to limit the apparatus to use in any particular orientation.

In order that the invention may be more easily understood and put into practical effect, reference will now be made to the accompanying drawings wherein:

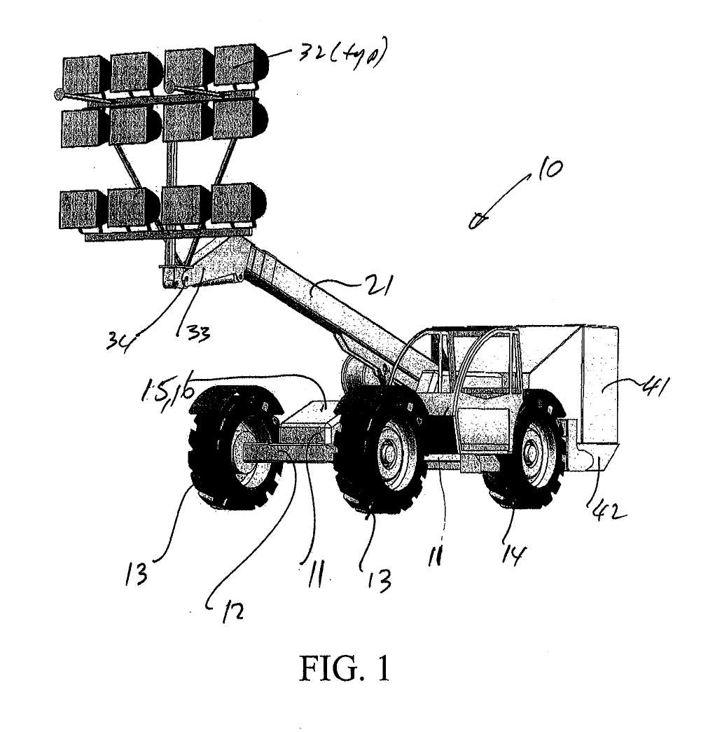

FIG. 1 is a perspective view of lighting apparatus according to the invention from the front towards one side with the boom in the fully lowered and retracted position;

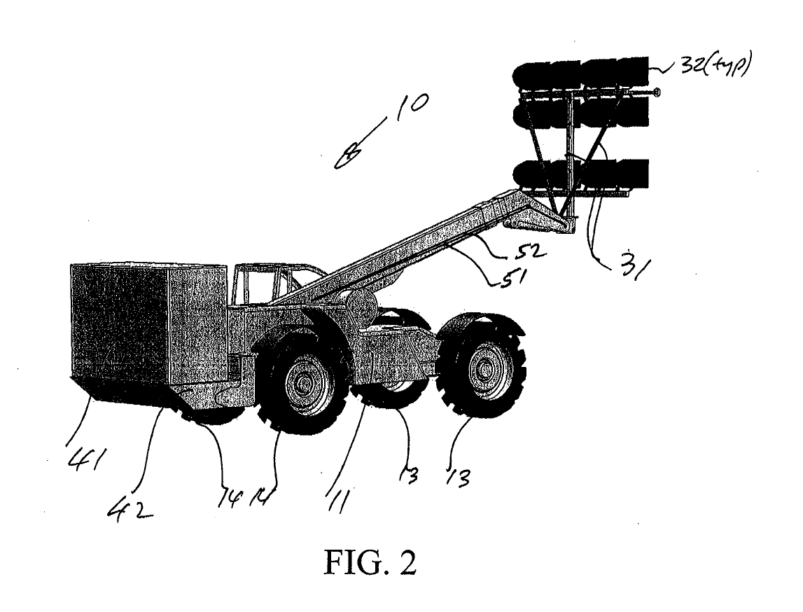

FIG. 2 is a perspective view of the apparatus of FIG. 1 from the rear towards the other side with the boom in the same position;

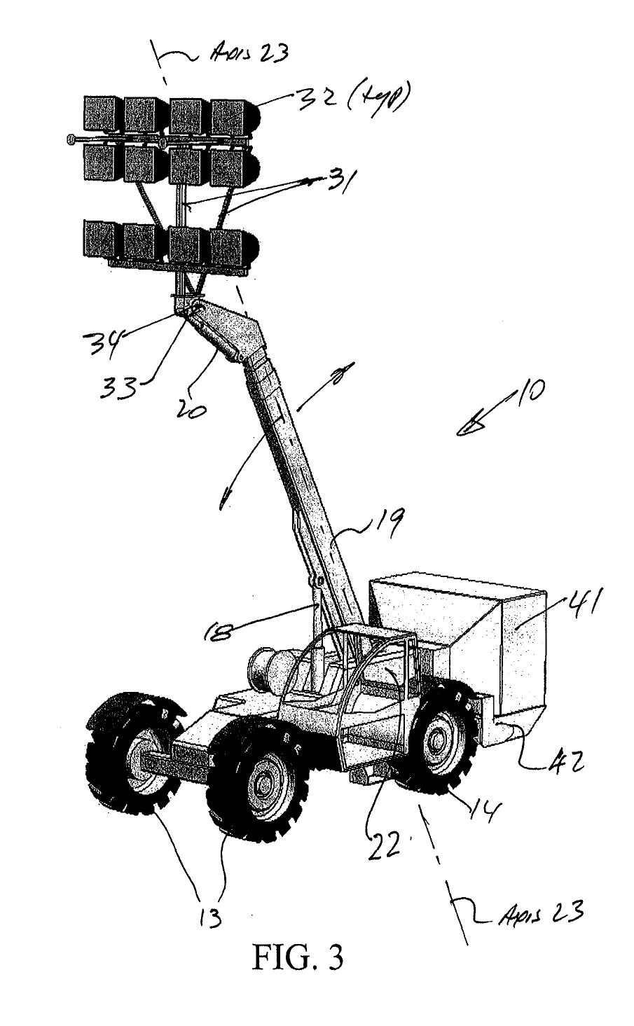

FIG. 3 is a perspective view of the apparatus of FIG. 1 from the front towards one side with the boom in the fully raised position and fully retracted; and

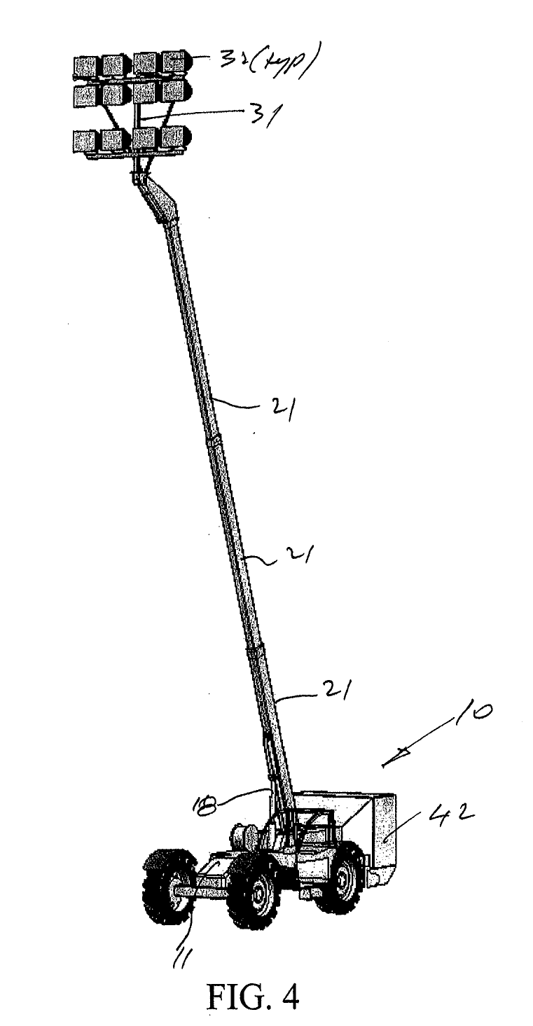

FIG. 4 is a perspective view of the apparatus of FIG. 1 from the same position as in FIG. 3 with the boom in the fully raised position and fully extended.

The lighting apparatus 10 illustrated in FIG. 1 has been converted from lifting apparatus according to the method previously described.

The lighting apparatus 10 includes a body 11 integrally formed with a chassis 12 which is supported on two spaced apart front wheels 13 and two spaced apart rear wheels 14 which are drivingly connected to a rear drive axle assembly in known manner for providing motive power to the wheels from the drive engine 15 and gearbox 16 mounted within the body 11.

The front wheels are mounted on king pins or the like and are arranged to pivot about respective vertical (or near vertical) axes through the king pins for steering the apparatus in known manner. However, in other forms of the invention, the body is an articulated body comprising a front half and a rear half which are connected by a vertical pivot pin arranged to allow the two halves to pivot relative to each other about a vertical axis intermediate the two halves in known manner to steer the vehicle. In such case, the front and rear wheels are fixed to their respective halves and pivoting of the two halves is achieved by hydraulic rams as is known in relation to cranes and similar vehicles.

An extendable boom 21 is mounted to the body for up and down movement about a horizontal pivot pin 22 (which is hidden behind body panels in the drawings) in known manner for apparatus of this type so that the boom can be raised and lowered with its longitudinal axis 23 remaining generally in the same vertical plane.

The drive engine also drives a hydraulic pump 17 (hidden in the body) for supplying hydraulic fluid to the boom rams 18, 19 and 20 in known manner for raising and lowering and extending and retracting the boom 21 as will be understood by the skilled addressee.

A lighting frame 31 having an array of lights 32 mounted thereon is connected to the outer end 33 of the boom by a pivot pin 34 for up and down movement relative to the boom with the hydraulic ram 20 arranged to selectively raise and lower the frame.

The lights in the array are powered by a diesel engine driven generator unit 41 which is bolted to a support platform 42 extending from the rear of the body 11. Advantageously, the generator unit is mounted in a predetermined position so as to provide a suitable counterweight to the boom and the lighting frame as well as the frame and lights attached thereto.

A power cable 51 extends from the generator unit 41 along a cable rack 52 on the offside of the boom and is connected to a distribution box (not shown) mounted on the lighting frame 32. Smaller cables distribute power from the distribution box to individual lights 32 mounted on the frame.

In use, when temporary lighting is required at a site, for example for machinery breakdown repairs, road works, sporting events and the like, the lighting apparatus can be driven to the site at a suitable road speed where the boom can be raised and extended to a desired elevated position and the generator started to supply power to the lights.

In the apparatus illustrated in FIG. 1 the generator unit has a 50 KVA generator and the array of lights take 24 KW so it will be appreciated that the generator has sufficient capacity to provide for a more powerful array of lights if desired. The boom of the apparatus illustrated is selected to be able to hold the array of lights at a height of approximately 20 metres above the ground. However, apparatus of greater or lesser lighting power and greater or lesser boom length could be constructed if desired. Notably, the generator unit has a substantial weight and in the embodiment described that weight is sufficient to provide an effective counterweight for the boom and lighting frame and array of lights without any other counterweight. Thus, it will be appreciated that the present invention provides apparatus in which the usual counterweight can be discarded or omitted and its task can be fulfilled by the generator unit (which might include a fuel tank) thus economising on space and length and improving efficiency.

The foregoing description has been given by way of illustrative example of the invention and many modifications and variations which will be apparent to persons skilled in the art may be made without departing from the spirit and scope of the invention as defined by the appended claims.

1. Mobile lighting apparatus, including:
a steerable vehicle having a body supported on a pair of spaced apart rear wheels and a pair of spaced apart front wheels;
drive means operatively connected to at least one of said pair of rear wheels and said pair of front wheels for driving the vehicle along the ground;
an extendable boom pivotally mounted to said body at or near its rear end for movement relative thereto between a lowered position and a raised position with the longitudinal axis of the boom remaining generally in the same vertical plane relative to the rear wheels;
lighting means operatively connected to said boom at or adjacent its end distal from said vehicle body;
electricity generation means mounted to said vehicle body behind said extendable boom adjacent its proximal end whereby said electricity generation means acts as a counterweight for said boom and said lighting means; and
electricity communication means connecting said electricity generation means to said lighting means.

2. Mobile lighting apparatus according to claim 1 wherein said electricity generation means includes an internal combustion engine and an alternator or generator coupled thereto.

3. Mobile lighting apparatus according to claim 1 wherein said electricity generation means is mounted on a platform which overhangs said body such that in use, the platform is closer to the ground than the body whereby in use if the rear wheels sink into the ground the platform may engage the ground and support the body.

4. Mobile lighting apparatus according to claim 1 wherein said drive means includes an engine and gearbox or one or more hydraulic motors drivingly connected to the wheels independently of the electricity generation means for road travel at speeds above about 30 kph.

5. Mobile lighting apparatus according to claim 1 wherein said lighting means includes a frame having an array of lights mounted thereon.

6. Mobile lighting apparatus according to claim 5 wherein said frame is operatively connected to said boom for up and down movement relative thereto.

7. Mobile lighting apparatus according to claim 6 including one or more hydraulic rams for causing up and down movement of said frame relative to said boom.

8. Mobile lighting apparatus according to claim 1 wherein said electricity communication means includes a cable extending along the side of the boom and connected to a distribution box mounted on the lighting frame.

9. A method of converting a vehicle to lighting apparatus, the vehicle being a steerable vehicle having a body supported on a pair of spaced apart rear wheels and a pair of spaced apart front wheels and drive means operatively connected to at least one of said pair of front wheels and said pair of rear wheels for driving the vehicle along the ground, an extendable boom pivotally mounted to said body at or near its rear end for movement relative thereto between a lowered position and a raised position with the longitudinal axis of the boom remaining generally in the same vertical plane relative to the rear wheels, and a counterweight mounted to said body to counter the weight of the boom, the method including:
connecting lighting means to said boom at or adjacent its distal end;
removing the counterweight at least in part and mounting electricity generation means to said body in a predetermined position in place of the removed counterweight; and
connecting the electricity generation means to the lighting means for electrical communication therewith.

10. A method according to claim 9 wherein said predetermined position is selected such that the electricity generation means acts as a suitable counterweight for the boom and the lighting means mounted thereon when fully extended.

11. Mobile lighting apparatus, including:
a steerable vehicle having a body supported on a pair of spaced apart rear wheels and a pair of spaced apart front wheels;
drive means operatively connected to at least one of said pair of rear wheels and said pair of front wheels for driving the vehicle along the ground;
an extendable boom pivotally mounted to said body at or near its rear end for movement relative thereto between a lowered position and a raised position with the longitudinal axis of the boom remaining generally in the same vertical plane relative to the rear wheels;
lighting means operatively connected to said boom at or adjacent its end distal from said vehicle body;
electricity generation means mounted to said vehicle body beside said extendable boom adjacent its proximal end; and
electricity communication means connecting said lighting means to said electricity generation means.
